(19) United States
(12) Patent Application Publication
(10) Pub. No.: US 2024/0257642 A1
(43) Pub. Date: Aug. 1, 2024

(54) SYSTEM FOR VEHICLE MOVEMENT MANAGEMENT

(71) Applicant: TOYOTA JIDOSHA KABUSHIKI KAISHA, Toyota-shi Aichi-ken (JP)

(72) Inventors: Hiroya CHIBA, Fuji-shi Shizuoka-ken (JP); Tatsuya Sugano, Sunto-gun Shizuoka-ken (JP); Ryuji Okamura, Gotemba-shi Shizuoka-ken (JP); Noriyuki Tsuruoka, Susono-shi Shizuoka-ken (JP); Daisuke Kakuma, Susono-shi Shizuoka-ken (JP)

(73) Assignee: TOYOTA JIDOSHA KABUSHIKI KAISHA, Toyota-shi Aichi-ken (JP)

(21) Appl. No.: 18/532,434

(22) Filed: Dec. 7, 2023

(30) Foreign Application Priority Data
Feb. 1, 2023 (JP) 2023-014246

(51) Int. Cl. G08G 1/14; G08G 1/127

(52) U.S. Cl. CPC G08G 1/149; G08G 1/127

(57) ABSTRACT

The present disclosure proposes a system for managing movement of vehicles in a predetermined area including a parking lot, a pick-up and drop-off area, and a baggage delivery area. The system comprises one or more processors configured to execute a parking process of parking a vehicle stopping at the pick-up and drop-off area in the parking lot. The parking process includes the following first to third processes. The first process is checking whether or not there is a checked baggage scheduled to be collected from the vehicle at the baggage delivery area. The second process is moving the vehicle from the pick-up and drop-off area to the baggage delivery area when there is the checked baggage. The third process is parking the vehicle in the parking lot in response to the checked baggage being collected from the vehicle after the vehicle is moved to the baggage delivery area.

### CROSS-REFERENCE TO RELATED APPLICATION

The present application claims priority to Japanese Patent Application No. 2023-014246, filed on Feb. 1, 2023, the contents of which application are incorporated herein by reference in their entirety.

### BACKGROUND

### Technical Field

The present disclosure relates to a technique for managing movement of vehicles in a predetermined area.

### Background Art

Patent Literature 1 discloses an information processing apparatus including a controller configured to execute:
transmitting a control command to cause a first autonomous driving vehicle for carrying a user and a second autonomous driving vehicle for carrying a user's baggage to travel in a row from a boarding point of the user to an airport; and
transmitting a control command to cause the first autonomous driving vehicle to move to a passenger terminal and the second autonomous driving vehicle to move to a cargo handling site after arrival at the airport.

In addition, the following Patent Literature 2 is a document showing the technical level of the present technical field.

### LIST OF RELATED ART

Patent Literature 1: JP 2020135028 A
Patent Literature 2: JP 2020166764 A

### SUMMARY

A user who uses a parking lot of a facility such as an airport or a hotel may be scheduled to check in a baggage loaded on a vehicle. However, taking the baggage out of the vehicle and carrying the baggage to a storage location, or carrying out procedures at the storage location is one of the actions that the users find troublesome.

According to the technique disclosed in Patent Literature 1, two autonomous driving vehicles, that is, the first autonomous driving vehicle and the second autonomous driving vehicle are used. Therefore, the introduction cost is high, and it is difficult to spread the method to general users.

In view of the above problems, an object of the present disclosure is to provide a technique capable of reducing the troublesome of a user who is scheduled to check in a baggage loaded on a vehicle.

One aspect of the present disclosure is directed to a system for managing movement of vehicles in a predetermined area including a parking lot, a pick-up and drop-off area, and a baggage delivery area.

The system comprises one or more processors configured to execute a parking process of parking a vehicle stopping at the pick-up and drop-off area in the parking lot in response to a parking request from a user.

The parking process includes:
checking whether or not there is a checked baggage scheduled to be collected from the vehicle at the baggage delivery area;
when there is the checked baggage, moving the vehicle from the pick-up and drop-off area to the baggage delivery area; and
after the vehicle is moved to the baggage delivery area, parking the vehicle in the parking lot in response to the checked baggage being collected from the vehicle.

According to the present disclosure, it is possible to reduce the troublesome of a user who is scheduled to check in a baggage loaded on a vehicle.

### BRIEF DESCRIPTION OF DRAWINGS

FIG. 1 is a conceptual diagram for explaining an outline of a parking function by a system according to the present embodiment;

FIG. 2 is a conceptual diagram for explaining an outline of a vehicle dispatch function by the system according to the present embodiment;

FIG. 3 is a diagram showing a configuration of the system according to the present embodiment;

FIG. 4 is a flowchart showing an example of a parking process executed by one or more processors according to the present embodiment;

FIG. 5 is a flowchart showing an example of a vehicle dispatch process executed by the one or more processors according to the present embodiment; and

FIG. 6 is a flowchart showing a process executed by one or more processors in a system according to a modified embodiment.

### DETAILED DESCRIPTION

Hereinafter, embodiments will be described with reference to the drawings.

### 1. Outline

A system according to the present embodiment is an AVP system provides a user with an auto valet parking (AVP) function in a predetermined area. The predetermined area to which the AVP system according to the present embodiment is applied is formed to include a parking lot, a pick-up and drop-off area, and a baggage delivery area. The pick-up and drop-off area is a place for the user to get on and off the vehicle. The baggage delivery area is a place for collecting the package. The AVP system according to the present embodiment is typically applied to an area including a parking lot of an airport. In this case, the package to be collected in the baggage delivery area is assumed to be a package that the user intends to carry to the destination.

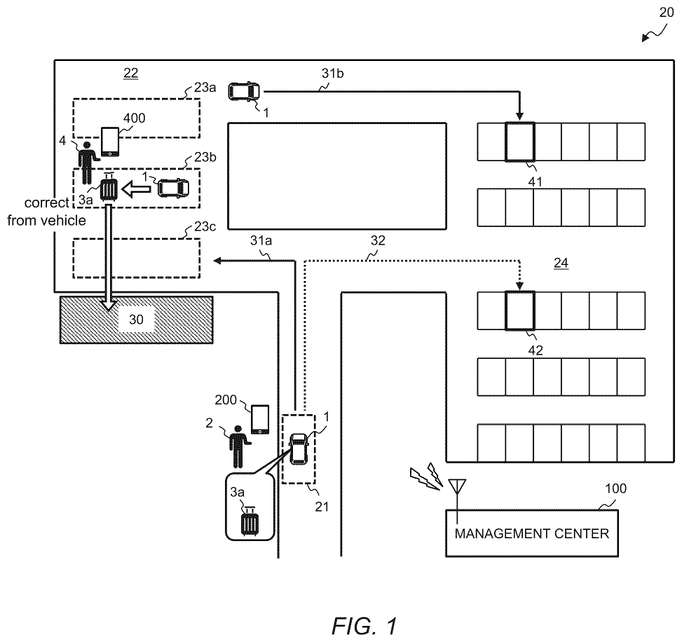

One of the AVP functions provided by the AVP system according to the present embodiment is a parking function of parking a vehicle stopping in a pick-up and drop-off area in a parking lot in response to a parking request from a user. Hereinafter, an outline of the parking function will be described with reference to FIG. 1.

FIG. 1 shows an example of a predetermined area 20 to which the AVP system according to the present embodiment is applied. The area 20 illustrated as an example in FIG. 1 includes a parking lot 24, a pick-up and drop-off area 21, and a baggage delivery area 22, which are connected to each other by a road through which vehicles can pass. The baggage delivery area 22 is provided in a baggage storage facility 30 which is a collection destination of the baggage. The baggage storage facility 30 is, for example, a facility for hand baggage storage services at airports. The baggage delivery area 22 includes three working spaces 23a, 23b, and 23c for the staff 4 to perform work.

First, the user 2 operates the user device 200 to transmit a parking request to the management center 100. At this time, it is assumed that the user 2 stops the vehicle 1 in the pick-up and drop-off area 21 and gets off the vehicle 1. The user device 200 is, for example, a smartphone, a tablet terminal, or the like. In this case, the user device 200 may be configured to enable the AVP function on a predetermined application. However, the user device 200 may be a dedicated terminal for configuring the AVP system. For example, the user device 200 may be a dedicated terminal installed in the pick-up and drop-off area 21.

When the parking request is received, the management center 100 communicates with the vehicle 1 that is a target for stopping in the pick-up and drop-off area 21, and starts the movement of the vehicle 1 by the parking function. The management center 100 manages the movement of the vehicle 1 in the area 20 by transmitting instruction information to the vehicle 1. The instruction information is information such as a destination point, a corridor for the movement, and a parking position. The vehicle 1 is configured to perform autonomous driving in the area 20 in accordance with instruction information received from the management center 100.

In the parking function according to the present embodiment, it is determined whether or not there is a checked baggage 3a scheduled to be collected from the vehicle 1 in the baggage delivery area 22. The checked baggage 3a is, for example, a package scheduled to be deposited to a destination by a hand baggage storage service at an airport. When there is a checked baggage 3a, the management center 100 moves the vehicle 1 to the baggage delivery area 22 and stops the vehicle 1 in any one of the working spaces. For example, the management center 100 transmits instruction information indicating a travel path 31a from the pick-up and drop-off area 21 to the baggage delivery area 22 and a working space 23b where collection work is performed to the vehicle 1. In the parking function according to the present embodiment, the user 2 having the checked baggage 3a can leave the pick-up and drop-off area 21 while the checked baggage 3a is loaded on the vehicle 1.

On the other hand, when there is no checked baggage 3a, the management center 100 parks the vehicle 1 in the parking lot 24. For example, the management center 100 transmits instruction information indicating the travel path 32 from the pick-up and drop-off area 21 to the parking lot 24 and the parking spot 42 as the parking position to the vehicle 1.

The vehicle 1 moves to the baggage delivery area 22 according to the instruction information and stops in any one of the working spaces, and thus the staff 4 can start the collection work of the checked baggage 3a. When the collection work is completed, a collection completion signal indicating that the pickup of the checked baggage 3a is completed is transmitted to the management center 100. For example, when the collection work is completed, the staff 4 operates the staff device 400 to transmit a collection completion signal. In this case, the staff device 400 may be configured to be able to transmit the collection completion signal on condition that the checked baggage 3a and the user 2 are collated. For example, the staff device 400 is configured to perform verification between the identification information of the user 2 received from the management center 100 and the identification information of the user 2 acquired by reading the identification codes attached in advance to the checked baggage 3a. By applying such a configuration, it is possible to improve the manageability of the pickup of checked baggage 3a in the baggage delivery area 22.

The staff terminals 400 may be terminals that operate on a predetermined application or may be a dedicated terminal for configuring an AVP system.

When the collection completion signal is received, the management center 100 determines that the checked baggage 3a has been collected from the vehicle 1, and parks the vehicle 1 stopping in the baggage delivery area 22 in the parking lot 24. For example, the management center 100 transmits instruction information indicating a travel path 31b from the baggage delivery area 22 to the parking lot 24 and the parking spot 41 as a parking position to the vehicle 1.

The parking function according to the present embodiment is completed when the vehicle 1 is parked in the parking lot 24.

As described above, the AVP system according to the present embodiment provides the parking function. When there is a checked baggage 3a, the parking function according to the present embodiment performs pickup of the checked baggage 3a together with parking of the vehicle 1. Thus, the user 2 does not need to carry the checked baggage 3a to the storage location or perform a procedure at the storage location. In addition, the inconvenience of the user 2 can be reduced.

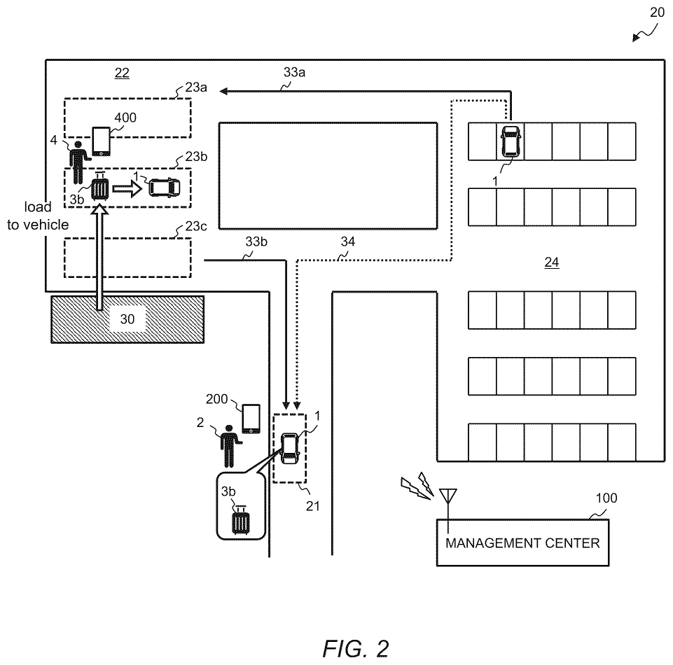

Another one of the AVP functions provided by the AVP system according to the present embodiment is a dispatch function of dispatching the vehicle 1 to be parked in the parking lot 24 in response to a vehicle dispatch request from the user 2. Hereinafter, an outline of the vehicle dispatch function will be described with reference to FIG. 2. The area 20 shown in FIG. 2 is the same as that shown in FIG. 1.

First, the user 2 operates the user device 200 to transmit a vehicle dispatch request to the management center 100. At this time, it is assumed that the user 2 is waiting in the pick-up and drop-off area 21 or is moving toward the pick-up and drop-off area 21.

When the management center 100 receives the vehicle dispatch request, the management center 100 communicates with the vehicle 1 to be parked in the parking lot 24 and starts moving the vehicle 1 by the vehicle dispatch function.

In the vehicle dispatch function according to the present embodiment, it is determined whether or not there is a pickup baggage 3b that the vehicle 1 is scheduled to pickup in the baggage delivery area 22. The pickup baggage 3b is, for example, a package that is scheduled to be picked up at a destination by a hand baggage storage service at an airport. When there is a pickup baggage 3b, the management center 100 moves the vehicle 1 to the baggage delivery area 22 and stops the vehicle 1 in any one of the working spaces. For example, the management center 100 transmits instruction information indicating a travel path 33a from the parking lot 24 to the baggage delivery area 22 and a working space 23b where collection work is performed to the vehicle 1.

On the other hand, when there is no pickup baggage 3b, the management center 100 moves the vehicle 1 to the pick-up and drop-off area 21. For example, the management center 100 transmits instruction information indicating the travel path 34 from the parking lot 24 to the pick-up and drop-off area 21 to the vehicle 1.

The vehicle 1 moves to the baggage delivery area 22 in accordance with the instruction information and stops in any one of the working spaces, and thus the staff 4 can start the loading work of loading the pickup baggage 3b on the vehicle 1. When the loading work is completed, a loading completion signal indicating that the pickup baggage 3b is loaded on the vehicle 1 is transmitted to the management center 100. For example, when the loading work is completed, the staff 4 operates the staff device 400 to transmit a loading completion signal. In this case, the staff device 400 may be configured to be able to transmit the loading completion signal on condition that the pickup baggage 3b and the user 2 are collated.

When the loading completion signal is received, the management center 100 moves the vehicle 1 stopping in the baggage delivery area 22 to the pick-up and drop-off area 21. For example, the management center 100 transmits instruction information for instructing a travel path 33b from the baggage delivery area 22 to the pick-up and drop-off area 21 to the vehicle 1.

When the vehicle 1 moves to the pick-up and drop-off area 21 and stops, the vehicle dispatch function according to the present embodiment is completed. After the vehicle dispatch function is completed, the user 2 can get on the vehicle 1 stopping in the pick-up and drop-off area 21 and start driving the vehicle 1.

As described above, the AVP system according to the present embodiment provides a vehicle dispatch function. When there is a pickup baggage 3b, the pickup baggage 3b is loaded on the vehicle 1 by the vehicle dispatch function according to the present embodiment, together with the allocation of the vehicle 1. Thus, the user 2 does not need to take over the pickup 3b or carry the pickup 3b to the pick-up and drop-off area 21. In addition, the inconvenience of the user 2 can be reduced.

### 2. Configuration

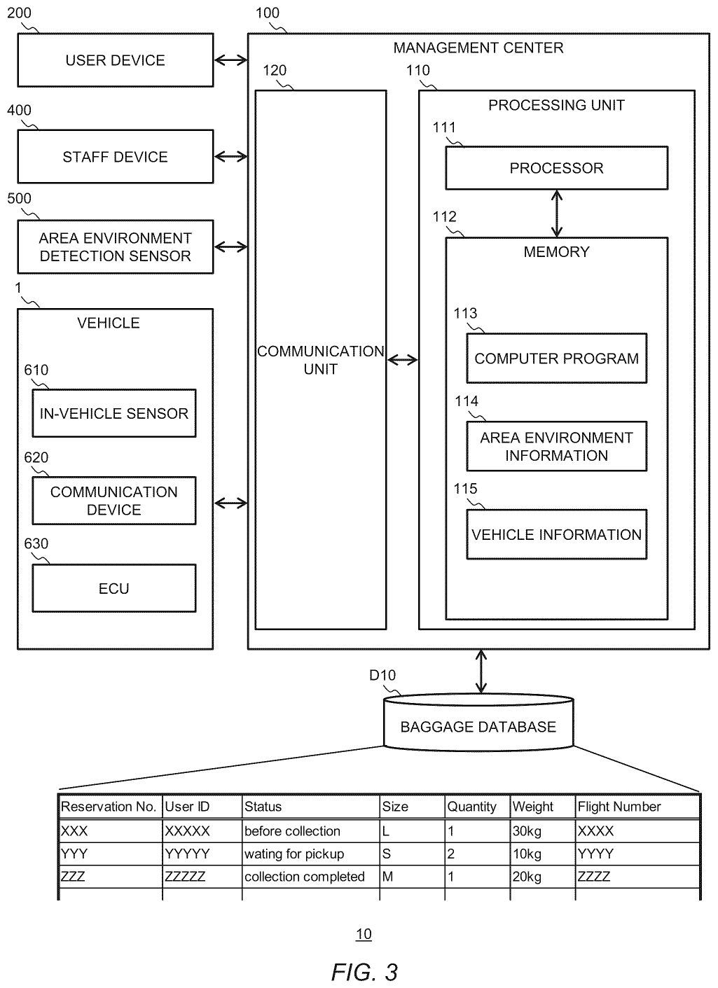

The configuration of the AVP system according to the present embodiment will be described below. FIG. 3 is a diagram showing an example of the configuration of the AVP system 10 according to the present embodiment.

The management center 100 is configured to communicate with the user device 200, the staff device 400, the area environment detection sensor 500, and the vehicle 1. For example, the management center 100 is connected to these devices via a moving body communication network or the Internet.

The area environment detection sensor 500 is a sensor that is installed in a predetermined area 20 and detects the environment of the area 20. For example, the area environment detection sensor 500 acquires the availability of the parking lot 24, acquires the availability of the working space, recognizes the vehicle 1 in the area 20 (position, traveling status, and the like), recognizes a pedestrian or an obstacle in the area 20, and the like. The area environment detection sensor 500 is configured by, for example, one or a plurality of cameras that image the situation in the area 20, an arranged vehicle detection sensor in the parking space of the parking lot 24, or the like.

The vehicle 1 includes an in-vehicle sensor 610, a communication device 620, and an ECU 630.

The in-vehicle sensor 610 detects information related to the driving environment of the vehicle 1. Examples of the in-vehicle sensor 610 include sensors that detect the surrounding environment of the vehicle 1 (preceding vehicle, white line, obstacle, and the like) such as a camera, a millimeter wave radar, and a LiDAR, and sensors that detect the traveling status of the vehicle 1 (vehicle speed, acceleration, yaw rate, and the like) such as a wheel speed sensor and an inertial measurement unit (IMU).

The communication device 620 communicates with a device outside the vehicle 1 to transmit and receive information. In particular, the communication device 620 communicates with the management center 100 to receive instruction information. The communication device 620 is, for example, a communication module that performs moving body communication.

The ECU 630 executes processing related to various controls of the vehicle 1. At least the ECU 630 is configured to execute a process of performing automated autonomous driving of the vehicle 1 in accordance with instruction information received from the management center 100. For example, the ECU 630 executes a process of generating a travel trajectory of the vehicle 1 so as to satisfy instruction information on the basis of information detected by the in-vehicle sensor 610, and a process of controlling acceleration, braking, and steering of the vehicle 1 so that the vehicle 1 travels along the travel trajectory. However, a suitable known technique may be applied to the processing related to the autonomous driving.

The management center 100 is configured to be able to access a baggage database D10. For example, the baggage database D10 is stored in a database server on the Internet, and the management center 100 accesses the baggage database D10 by communicating with the database server via the Internet.

The baggage database D10 manages information of the package to be collected in the baggage delivery area 22 for each user 2. The baggage database D10 is configured by, for example, reservation hand baggage storage when the user 2 reserves an airport guidance service. FIG. 3 shows an example of information on a package managed by the baggage database D10. In the example illustrated in FIG. 3, the baggage database D10 manages various information of the package to be collected in the baggage delivery area 22 in association with the user IDs which are identification information of the users 3. In the example illustrated in FIG. 3, as the information of the package to be managed, a status of collection, attribute information (size, quantity, weight), and a flight number for specifying a storage destination of the package are illustrated.

The management center 100 includes a processing unit 110 and a communication unit 120.

The processing unit 110 is a computer including one or more processors 111 (hereinafter, simply referred to as “processor 111”) and one or more memories 112 (hereinafter, simply referred to as “memory 112”).

The processor 111 executes various processes related to the management center 100. The processor 111 can be configured by, for example, a central processing unit (CPU) including an arithmetic device, a register, and the like. The memory 112 is connected to the processor 111 and stores various kinds of information necessary for the processor 111 to execute processing. The memory 112 may be configured by a recording medium such as a read only memory (ROM), a random-access memory (RAM), a hard disk drive (HDD), or a solid state drive (SSD).

The memory 112 stores a computer program 113, area environment information 114, and vehicle information 115.

The computer program 113 is stored in a computer-readable recording medium. The computer program 113 is configured by a plurality of instructions for causing the processor 111 to execute processing. The processor 111 operates in accordance with the plurality of instructions, and thus the processor 111 executes various processes.

The area environment information 114 is information detected by the area environment detection sensor 500. The area environment information 114 may further include map information of a predetermined area 20.

The vehicle information 115 is information related to the vehicle 1. The vehicle information 115 includes, for example, position information of the vehicle 1 in a predetermined area 20, a traveling status of the vehicle 1, and identification information of the vehicle 1. The management center 100 may be configured to acquire the vehicle information 115 from the vehicle 1.

The communication unit 120 communicates with an external device of the management center 100 to transmit and receive information. The management center 100 transmits and receives information to and from the user device 200, the staff device 400, the area environment detection sensor 500, and the vehicle 1 through the communication unit 120. In particular, the communication unit 120 communicates with the vehicle 1 to transmit instruction information. The communication unit 120 is, for example, a device that connects to the Internet and communicates.

### 3. Process

Hereinafter, processing executed by the management center 100, more specifically, processing executed by the processor 111 will be described.

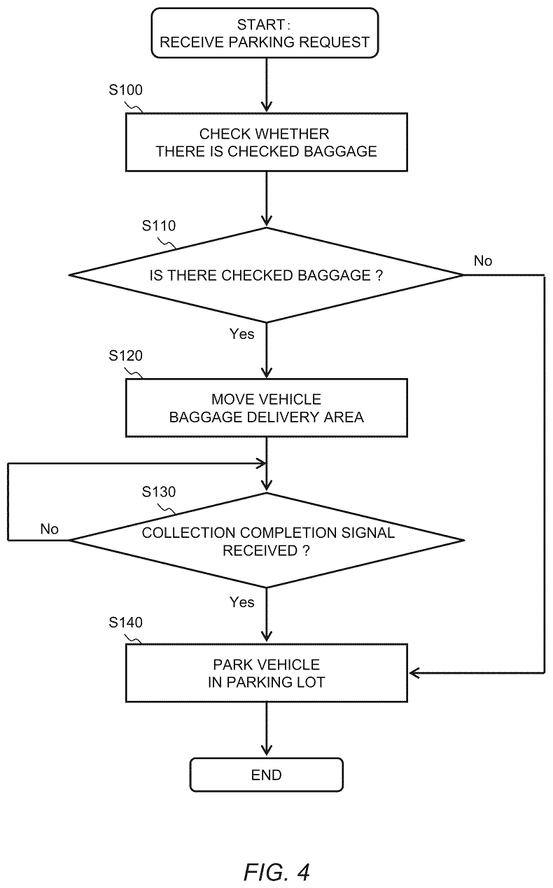

First, a parking process executed by the processor 111 in the parking function will be described with reference to FIG. 4. The process illustrated in FIG. 4 is started when the management center 100 receives a parking request.

In step S100, the processor 111 acquires the presence or absence of a checked baggage 3a of the user 2. For example, the processor 111 acquires the presence or absence of a checked baggage D10 of the user 2 by referring to the baggage database 3a using the userID of the user 2. In this case, the parking request may include information of the user ID.

When the checked baggage 3a exists (step S110; Yes), the processing proceeds to step S120. If there is no checked baggage 3a (step S110; No), the process proceeds to step S140.

In step S120, the processor 111 generates instruction information to move the vehicle 1 from the pick-up and drop-off area 21 to the baggage delivery area 22. For example, the processor 111 selects a workable working space from the area environment information 114, and generates instruction information indicating the selected working space and the corridors for the movement from the pick-up and drop-off area 21 to the baggage delivery area 22. After the vehicle 1 moves to the baggage delivery area 22 in accordance with the instruction information, the process proceeds to step S130.

In step S130, the processor 111 determines whether or not a collection completion signal has been received. That is, the processor 111 determines whether or not the checked baggage 3a is collected from the vehicle 1 in the baggage delivery area 22.

When the collection completion signal is received (step S130; Yes), the processing proceeds to step S140. When the collection completion signal is not received (step S130; No), the processor 111 executes the process related to step S130 again at a predetermined processing cycle.

In operation S140, the processor 111 generates instruction information to park the vehicle 1 in the parking lot 24. For example, the processor 111 selects a parking position where the vehicle can be parked from the area environment information 114, and generates instruction information indicating the selected parking position and a corridors for the movement to the parking lot 24.

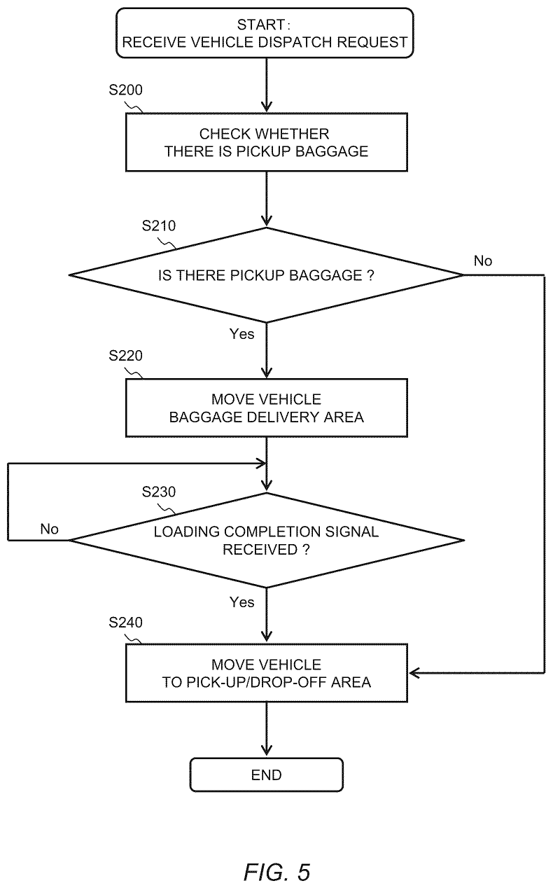

Next, a process (vehicle dispatch process) executed by the processor 111 in the vehicle dispatch function will be described with reference to FIG. 5. The process shown in FIG. 5 is started when the management center 100 receives a vehicle dispatch request.

In step S200, the processor 111 acquires the presence or absence of a pickup 3b of the user 2. For example, the processor 111 acquires the presence or absence of a pickup baggage D10 of the user 2 by referring to the baggage database 3b using the user ID of the user 2. In this case, the vehicle dispatch request may include information of the user ID.

If the pickup baggage 3b exists (step S210; Yes), the process proceeds to step S220. If there is no pickup baggage 3b (step S210; No), the process proceeds to step S240.

In step S220, the processor 111 generates instruction information to move the vehicle 1 from the parking lot 24 to the baggage delivery area 22. After the vehicle 1 moves to the baggage delivery area 22 in accordance with the instruction information, the process proceeds to step S230.

In step S230, the processor 111 determines whether or not the loading completion signal has been received. That is, the processor 111 determines whether or not the pickup baggage 3b is loaded on the vehicle 1 in the baggage delivery area 22.

When the loading completion signal is received (step S230; Yes), the processing proceeds to step S240. When the loading completion signal has not been received (No in step S230), the processor 111 executes the processing in step S230 again at a predetermined processing cycle.

In step S240, the processor 111 generates instruction information to move the vehicle 1 to the pick-up and drop-off area 21.

As described above, the AVP function of the AVP system 10 according to the present embodiment is realized by the processor 111 executing the processing. The AVP method according to the present embodiment is realized by the processor 111 executing the processing in this way. The AVP program according to the present embodiment is realized by the computer program 113 that causes the processor 111 to execute the processing in this way.

### 4. Modification

The AVP system 10 according to the present embodiment may be modified as follows. In the following description, the same parts as those described above are omitted as appropriate.

The management center 100 according to the modification is configured to determine the size of the workload involved in the collection work or the loading work of the checked baggage 3a or the pickup baggage 3b based on the attribute information of the checked baggage 3a or the pickup baggage 3b when the vehicle 1 is moved to the baggage delivery area 22 in the parking functions or the vehicle dispatch functions. The management center 100 is configured to stop the vehicle 1 in a working space having a shorter flow line distance as the size of the workload is larger.

For example, in the area 20 shown in FIG. 1, the working space 23a is farther from the baggage storage facility 30 than the working space 23b, and the working space 23b is farther from the baggage storage facility 30 than the working space 23c. That is, the flow line distance of the collection work or the loading work is longer in the order of the working space 23a, the 23b, and the 23c. Therefore, the management center 100 is configured to select a working space for stopping the vehicle 1 from the working spaces 23a, 23b, and 23c according to the size of the workload when the vehicle 1 is moved to the baggage delivery area 22 in the parking or dispatch functions. For example, when the management center 100 is configured to determine the size of the workload at a stepwise level such as “large”, “medium”, and “small”, the management center 100 is configured to select the working space 23a when the size of the workload is “small”, select the working space 23b when the size of the workload is “medium”, and select the working space 23c when the size of the workload is “large”.

When the parking function or the vehicle dispatch function is provided to a plurality of users, it is assumed that collection work or loading work is performed on a plurality of vehicles in the baggage delivery area 22. By applying the modified aspect, the working space can be efficiently utilized, and the work efficiency of the collection work or the loading work can be improved.

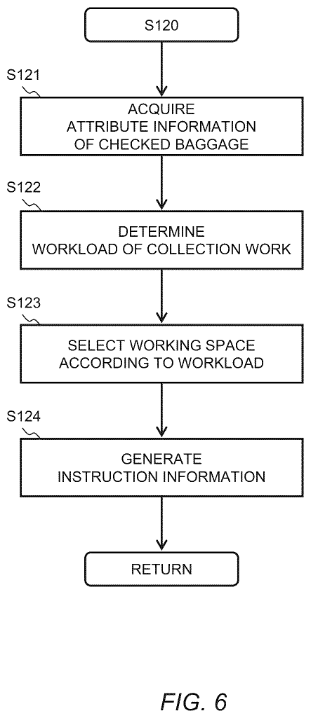

FIG. 6 is a diagram illustrating an example of a process executed by the processor 111 in the parking function according to the modification. The process shown in FIG. 6 is started when the processor 111 executes a process of generating instruction information to move the vehicle 1 from the pick-up and drop-off area 21 to the baggage delivery area 22 (the process related to step S120 in FIG. 4).

In step S121, the processor 111 acquires attribute information of the checked baggage 3a. For example, the processor 111 acquires the attribute information of the checked baggage D10 by referring to the baggage database 3a using the user ID of the user 2.

In operation S122, the processor 111 determines a size of a workload according to the collection work of the checked baggage 3a based on the attribute information obtained in operation S121. The processor 111 may determine the size of the workload using, for example, the size, quantity, and weight of the checked baggage 3a as indices. In this case, the processor 111 may determine that the workload is large as the size, the quantity, and the weight are large. The size of workload may be given in a stepwise manner such as “large”, “medium”, and “small” as described above, or may be given by a value obtained by digitizing workload.

In step S123, the processor 111 selects a working space in which the vehicle 1 is to be stopped, according to the size of the workload determined in step S122. Here, the processor 111 selects a collection space having a shorter flow line distance as the size of the workload is larger. The processor 111 may be configured to acquire the availability of each pickup space and the information of the flow line distance of each pickup space with reference to the area environment information 114.

In step S124, the processor 111 generates instruction information indicating the working space selected in step S123. After step S124, the execution of the process related to step S120 is terminated.

As described above, the parking function according to the modification is realized by the processor 111 executing the processing. The vehicle dispatch function according to the modification can also be realized by the processor 111 executing the same processing for the pickup baggage 3b.

What is claimed is:

1. A system for managing movement of vehicles in a predetermined area including a parking lot, a pick-up and drop-off area, and a baggage delivery area,
the system comprising one or more processors configured to execute a parking process of parking a vehicle stopping at the pick-up and drop-off area in the parking lot in response to a parking request from a user,
the parking process including:
checking whether or not there is a checked baggage scheduled to be collected from the vehicle at the baggage delivery area;
when there is the checked baggage, moving the vehicle from the pick-up and drop-off area to the baggage delivery area; and
after the vehicle is moved to the baggage delivery area, parking the vehicle in the parking lot in response to the checked baggage being collected from the vehicle.

2. The system according to claim 1, wherein
the parking process further includes, when there is no checked baggage, parking the vehicle in the parking lot without moving the vehicle to the baggage delivery area.

3. The system according to claim 1, wherein
the baggage delivery area includes a plurality of working spaces having different flow line distances for collection work respectively, and
the moving the vehicle from the pick-up and drop-off area to the baggage delivery area includes:
acquiring attribute information of the checked baggage;
determining a workload of the collection work for the checked baggage based on the attribute information; and
stopping the vehicle at a working space, among the plurality of working spaces, where the flow line distance is shorter as the workload is larger.

4. The system according to claim 1, wherein
the one or more processors are configured to determine that the checked baggage has been collected from the vehicle when receiving a collection completion signal showing that collection work for the checked baggage has been completed after the vehicle is moved to the baggage delivery area.

5. The system according to claim 1, wherein
the one or more processors are configured to further execute a vehicle dispatch process of dispatching the vehicle parking in the parking lot to the pick-up and drop-off area in response to a vehicle dispatch request from the user,
the vehicle dispatch process including:
checking whether or not there is a pickup baggage scheduled to be picked up at the baggage delivery area;
when there is the pickup baggage, moving the vehicle from the parking lot to the baggage delivery area; and
after the vehicle is moved to the baggage delivery area, moving the vehicle to the pick-up and drop-off area in response to the pickup baggage being loaded on the vehicle.
